(19) United States
(12) Patent Application Publication
(10) Pub. No.: US 2019/0104758 A1
(43) Pub. Date: Apr. 11, 2019

(54) Preemptions of Chronic Diseases

(71) Applicant: Anuthep Benja-Athon, New York, NY (US)

(72) Inventor: Anuthep Benja-Athon, New York, NY (US)

(21) Appl. No.: 15/727,644

(22) Filed: Oct. 9, 2017

(51) Int. Cl. A23L 33/115; G06F 19/00; A23L 33/175

(52) U.S. Cl. CPC A23L 33/115; A23L 33/105; A23L 33/175; G06F 19/3462

(57) ABSTRACT

A plurality of groups of chemicals, manipulations of genes and husbandry for reducing and preventing cardiovascular and cerebrovascular diseases and metabolic syndrome by reducing and suppressing the productions of the precursors of lipoproteins and lipids and metabolic syndrome involved in the arterial atherosclerosis by disrupting, decreasing and suppressing the activities of enzymes, co-enzymes, catalysts, hormones and digestive fluids and neural receptors. Networks and prints for monitoring and informing the aforementioned fulfillments, performances and achievements.

### FIELD OF THE INVENTION

Medicine and networked devices for preventing chronic diseases.

### SUMMARY OF THE INVENTION

Western diets promote the digestions and absorptions of dietary fats attributable to arterial diseases and metabolic syndrome and sequelae. The present invention is far superior than the status quo practice of medicine for attempting to prevent and treat cardiovascular and cerebrovascular diseases, metabolic syndrome and sequelae. A plurality of groups, compounds of chemicals and almagamated chemicals, gene-editing technologies and husbandry for preventing and reducing cardiovascular and cerebrovascular diseases and metabolic syndrome by reducing the productions of the precursors of plasma lipoproteins and lipids involved in the arterial atherosclerosis process. Said groups, compounds of chemicals and almagamated chemicals for disrupting, decreasing and suppressing digestion and hydrolysis activities of enzymes, co-enzymes, catalysts, hormones, bicarbonate and digestive fluids and neural receptors by modifying the stomach and small intestinal acid-base and fluid milieus and disrupting, reducing and suppressing said activities by disrupting the hydrolysis of hydrolysis substrates, the transportation of said hydrolysis products to the absorbing epithelial cells and by digesting said enzymes, co-enzymes, catalysts and hormones. Networks of communication devices and printed information and illustration for instructing, monitoring and informing said fulfillments, performances and achievements of said chemicals and method.

### BACKGROUND OF THE INVENTION

Chronic diseases afflicting 10% Americans costing $2 trillions of the $3.3 trillion healthcare costs per annum. And the epic crises are escalating as people are living longer albeit still less healthy. Among chronic diseases of people, the leading cause of morbidity and mortality of people in the western nations is cardiovascular and cerebrovascular diseases and related such as, but not limited, arterial atherosclerosis such as, but not limited to, coronary atherosclerosis and cerebrovascular atherosclerosis leading to coronary heart disease such as, but not limited, ischemic heart, myocardial infarction and stroke, etc., and numerous common sequalae including morbidity and mortality and related health, morbidity and mortality and socioeconomic consequences. Despite numerous categories of expensive and life-long drugs—the statins, cholesterol absorption and inhibitors, bile acid sequestrants, nicotinic acid, fibric acid derivatives and omega 3 fatty acids—theoretically, for lipidemias, hyperlipidemias and dyslipidemias consequent to daily ingestions of high dietary fats and calories by millions of people having truncal obesity also known as central obesity. Millions are committed to life-long treatments and adverse side-effects with moderate to severe permanent sequelae. The efficacies of these treatments—like unsubstantiated information on physical activities, nutritions and supplements—are questionable. $billions per annum are expanded on snail oil and placebo and related consequences. Moreover, the prevalent methods and practices of preparing and consuming Western diets daily by billions of people—are most inducive for human gastrointestine to most efficiently digest, hydrolysis and absorb the dietary fats. If said failed, interventional procedures are utilized for said people in their best decades of life being afflicted by said chronic morbidity and mortality.

The current and growing albeit unsustainable $trillions per annum of socioeconomic, healthcare, pharmaceutical and intangible costs burdening billions of people and nations can be rapidly obliterated by the present invention. In other words, The number of individuals using said medications continued to increase.

Supporting supra are scientific facts documented herein based on the present applicant's basic and clinical researches. So, millenia of myths, false claims and believes and daily unhealthy practices by billions are heretofore revealed so that billions will be healthier and long live.

### DESCRIPTION OF THE PREFERRED EMBODIMENTS

The present invention is a system and method for preventing and reducing cardiovascular and cerebrovascular diseases and metabolic syndrome by reducing and suppressing the productions and introductions of the hydrolysis products which are the precursors of the deleterious lipoproteins and lipids in the human hepatocytes and adipocytes. In present invention emphasizes the major hydrolysis substrate—the triglycerides also known as triacylglycerols in the animal fats being consumed by people—being digested and hydrolyzed into fatty acids and monoglycerides in the stomach, duodenum and jejunum by stomach, small intestinal, pancreatic and gall bladder enzymes, co-enzymes, catalysts, hormones and digestive fluids, bicarbonate, bile being aided by the neural receptors in said organs. Other products are cholesterols, lecithins and lysolecithins, etc.

The absorption of said hydrolysis products is very efficient by the absorbing epithelial cells of the duodenum and the first 100 cm of the jejunum. However, said digestions, productions and absorptions require that said biomechanism of and biochemical reactions in said digestions and hydrolysis must be precisely and accurately executed based on strict biological regulations and reactions in the normal stomach and small intestinal milieus. Based on said natural phenomena, the present invention disrupting, interfering and suppressing said biomechanism of and biochemical reactions and altering said stomach and small intestinal milieus to disrupt and suppress the productions at the source—stomach, duodenum and jejunum—thus availability of said precursors for liver and adipose tissue to synthesize and produce said lipids and lipoproteins in the relational events, diseases, disorders, morbidity and mortality described herein is schematically represented:

The hydrolysis of said dietary fats and absorption of said precursors by said absorbing epithelial cells>free fatty acids flux to the liver and adipose tissue>lipid and lipoprotein syntheses and metabolism by and flux out of the hepatocytes and adipocytes>apoB-containing triglyceride-rich VLDL production>hypertriglyceridemia>elevated hepatic VLDL synthesis>elevated hepatic LDL synthesis; elevated VLDL synthesis from simple carbohydrates>elevated hepatic LDL synthesis; elevated VLDL synthesis from simple carbohydrates>high-density cholesterol>increased HDL clearance>reduced HDL cholesterol>increased cholesterol-rich VLDLs>elevated atherogenic small dense LDL able to traverse inner arterial walls>atherosclerosis in vascular diseases>cardiovascular and cerebrovascular diseases.

The Metabolic syndrome—aging, sedentary>the hydrolysis of said dietary fats and absorption of said precursors by said absorbing epithelial cells>free fatty acids flux to the liver and central and truncal adipose tissue>increased insulin levels>promote hepatic fatty acid synthesis>pathogenesis of metabolic syndrome, obesity, central obesity also known as truncal obesity, lipodystrophy, changes in body mass index and waist-to-hip ratio>insulin resistance; diabetes; diabetes type 2>lipid and lipoprotein syntheses and metabolism by and flux out of the hepatocytes and adipocytes>dyslipidemia including hyperlipidemia and hypertriglyceridemia>hypertension>premature coronary heart disease; coronary heart disease; cardiovascular and cerebrovascular diseases.

The present invention producing and manufacturing a plurality of first, second, third, fourth and filth groups of chemicals, a plurality of compounds of said chemicals and a plurality almagamated chemicals—the latter when compounding of chemicals are not pharmaceutically feasible—for disrupting and suppressing said productions of said precursors which are said hydrolysis products comprising fatty acids, monoglycerides, cholesterols, lecithins and lysolecithins, etc. as further described supra.

Said first group of chemicals for modulating, reducing and inactivating hydrochloric acid, gastric enzymes, co-enzymes, hormones, catalysis and juice and neural receptors for generating and promoting said productions of precursors in said stomach, duodenum and jejunum. Said first group of chemicals for reducing and suppressing digestion and peptic hydrolysis of dietary fats such as, but not limited to, tributyrin which is a triglyceride naturally present in butter, dairy products and the likes. Tributyrin is an ester composed of butyric acid (a C4.0 short-chain lipid) and glycerol and is digested by gastric lipase with acid pH optimum of 5.5 in the stomach. In the small intestine, pancreatic lipase is inactive with tributyrin. Said first groups of chemicals are alkali comprising families of anions such as, but not limited to, carbonates, bicarbonates and hydroxides such as, but not limited to, cation carbonates, sodium bicarbonate, aluminum hydroxide and magnesium hydroxide. Said alkali inactivates hydrochloric acid, gastric enzymes, co-enzymes, hormones, catalysts and juice and neural receptors while conserving certain gastric enzymes such as, but not limited to, stomach pepsin—henceforth conserved stomach pepsin—for digestion in the small intestine as described infra. Calcium carbonate may be used albeit undesirable as calcium carbonate will yield calcium, for participating in and assisting pancreatic lipase in the productions of and transportation of said hydrolysis products in the small intestine. Sodium bicarbonate, aluminum hydroxide or magnesium hydroxide and compounds of same—in capsules, tablets, pills and the likes—can be ingested with meals comprising butter, cheeses and the likes composed of tributyrin. Sodium bicarbonate, aluminum hydroxide or magnesium hydroxide rendering alkali pH which disrupt and suppress digestion of tributyrin by gastric lipase.

Said first group of chemicals—represented herein by said sodium bicarbonate, aluminum hydroxide or magnesium hydroxide and the likes—rendering stomach close to or about pH 7—alkali pH. Stomach pepsin—an endopeptidase—is only active in an acid pH ranging from 1.0 to 4.0 depending on the substrates. First, said sodium bicarbonate, aluminum hydroxide and magnesium hydroxide reduce, disrupt and suppress the stomach enzymes such as, but not limited to, pepsin for digesting proteins and polypeptides into protein hydrolysates and amino acids which are some of the potent stimulators of the secretions and activations of duodenal and pancreatic enzymes, co-enzymes, hormones and catalysts, bile, bicarbonate, digestive fluid and neural receptors and the release of insulin.

Said first group of chemicals further comprises histamine H2-receptor blockers such as, but not limited to, omeprazole, lansoprazole, ranitidine, famotidine, nizatidine and cimetidine for achieving same objectives supra. Second, said conserved stomach pepsin in stomach chyme passes into the acid-pH duodenum—rendered by second group of chemicals infra—where said conserved stomach pepsin digests peptides such as, but not limited to, duodenal and pancreatic enzymes, co-enzymes, hormones and catalysts such as, but not limited to, pancreatic lipase, procolipase, colipase, cholecystokinin-pancreozymin, lecithinases, cholesterol ester hydrolase enterokinases, endopeptidases, exopeptidases, trypsinogen and trypsin.

Third, said sodium bicarbonate, aluminum hydroxide or magnesium, hydroxide and the likes—rendering chyme close to and at alkali pH to reduce and suppress the secretions and activations of duodenal and pancreatic enzymes, co-enzymes, hormones and catalysts, bile, bicarbonate, digestive fluid and neural receptors. As stated in the Claims, acidic foods, fluids, fruits and chyme, certain types of vegetable oils such as, but not limited to, oleate, protein hydrolysates, amino acids, fatty acids and water, sodium chloride and carbohydrate are potent stimulators of the secretion of secretin. Secretin stimulates the secretions of digestive fluid including bicarbonate and chloride and, furthermore, secretin stimulates the release of insulin by pancreas. Hydrochloric acid in the duodenum is the most potent stimulus of secretin release.

In addition, first exclusion of said acidic foods and fruits, acidic fluids such as, but not limited to, alcoholic and carbonated beverages, vinegars in salad dressings, fruit juices, tea and coffee and a long list of other acidic fluids being consumed by people and chyme, certain types of vegetable oils such as, but not limited to, oleate, protein hydrolysates, amino acids, fatty acids, water, sodium chloride and carbohydrate before, during and after meals will reduce and suppress said digestions and hydrolysis in the stomach and small intestine.

The approximate dosages of sodium bicarbonate are 1,000 mg-4,000 mg, aluminum hydroxide 100-400 mg and magnesium hydroxide 100-400 mg. However, said dosages can be titrated up and down in various types and quantities of meals to fulfill and achieve the goals and objectives of the present invention. Said medications in any combinations and proportions may be compounded into individual tablets, pills and capsules which are taken with meals.

Coated enteric second group of chemicals for modulating, reducing and suppressing the productions of said precursors in said small intestine, said second chemicals comprises chemicals for reducing and suppressing activities of stomach, duodenal and pancreatic enzymes, co-enzymes, catalysts, hormones and digestive fluids and neural receptors in the stomach, small intestine and brain for generating said precursors in said small intestine and the transportation and delivery of said precursors aka hydrolysis products to said absorbing epithelial cells, said chemicals for producing acid-pH duodenum and jejunum comprise:

first, ascorbic acid for producing said rendered acid-pH small intestine for suppressing the activities of said stomach, duodenal and pancreatic enzymes, co-enzymes, catalysts and hormones which are polypeptides and digestive fluids and neural receptors in the stomach,

said ascorbic acid tor producing acid pH for suppressing the emulsification by amino acids, lecithin, lysolecithin, fatty acids, monoglycerides, diglycerides, and bile acids, said ascorbic acid is coated enteric ascorbic acid being passed from stomach into the small intestine;

second, citric acid for producing acid pH for suppressing the activities of pancreatic lipase, procolipase, colipase, cholecystokinin-pancreozymin, cholesterol ester hydrolase, trypsinogen, trypsin, bile, fluid and bicarbonate,

in addition, second exclusion of amino acids, certain types of vegetable oils such as, but not limited to, oleate and corn oil, alcoholic and carbonated beverages, vinegars in salad dressings, fruit juices, tea and coffee and a long list of other acidic fluids, water which change the rates of cholecystokinin-pancreozymin release which causes the secretions of bile and pancreatic juice into the small intestine.

Citric acid for producing acid pH for suppressing the emulsification by amino acids, lecithin, lysolecithin, fatty acids, monoglycerides, diglycerides, and bile acids, said citric acid is coated enteric citric acid;

third, said citric acid for suppressing the role of calcium for hydrolysis and removing hydrolysis products into the aqueous phase, said citric acid is a chelating chemical for reducing and suppressing the activity of pancreatic lipase in said hydrolysis and said transportation of hydrolysis products at and away from said hydrolysis site so that said pancreatic lipase can remain active, said citric acid for chelating said calcium, said citric acid is a coated enteric chelating agent being passed from stomach into the small Intestine. Other organic chelating agents—oligomer, polymers and inorganic polyphosphate—are such as, but not limited to, PAA, pentasodium tripolyphosphate (STPP), ethylene diamine tetraacetic acid (EDTA), maleic acid oligomere (MAO), NTA and CMOS.

Said third group of chemicals for reducing and depriving said hydrolysis substrates for said pancreatic lipase and bile comprising coated enteric chemicals for competing for hydrolysis by pancreatic lipase and bile. Said chemicals comprise animal, plant, man-made and synthetic lipids and any combination thereof. Said third group of chemicals can be made from specific short-chain fatty acids, long-chain fatty acids, very long-chain fatty acids and glycerol moieties. Said chemicals being emulsified in the small intestine wherein said lipid-aqueous interface competing with dietary lipid-aqueous interface for pancreatic lipase at said interfaces where the pancreatic lipase is active. Because pancreatic lipase has substrate specificity—the rate of hydrolysis by pancreatic lipase is low for triglycerides with acetyl (C2) chains in the 1 position, is maximal for proprionyl (C3) and butryryl (C4), and decreases to a constant plateau for lauryl (C12) and longer chain. The animal, plant, man-made and synthetic lipids comprise short-chain fatty acids, long-chain fatty acids and very long-chain fatty acids at 1 position, 2 position and/or 3 position for producing said lipid-aqueous interface where pancreatic lipase is active but said moieties lack or have less specificity for said gastric lipase and pancreatic lipase. Furthermore, said animal, plant, man-made and synthetic lipids and any combination thereof can comprise saturated fat profile dissimilar to saturated fat profile said animal fats and unsaturated fat profile dissimilar to saturated fat profile of said animal fats. Said saturated fats such as, but not limited to, proprionic acid C3, butyric acid C4, valeric acid C5, caproic acid C6, enathic acid C7, . . . C8, . . . C9, . . . C10, . . . C11, lauric acid C12, . . . C13, myristic acid C14, . . . C15, palmatic acid C16, margaric acid C17, stearic acid C18, . . . C19, . . . C20, . . . C21, . . . C22, . . . C22, . . . C23, . . . C24, . . . C25, . . . C26, . . . C27, . . . C28, . . . C29, . . . C30, . . . C31, . . . C32, . . . C33, . . . C34, . . . C35, . . . C36, heptatriacontanoic acid C37, octatriacontanoic acid C38 and saturated fats and monosaturated fats and polyunsaturated fats in plant oils such as, but not limited to, canola oil, cashew oil, coconut oil, corn oil, cottonseed oil, olive oil, palm kernel oil, palm oil, peanut oil, rice bran oil, safflower oil, flaxseed oil, sesame oil, soya bean oil, almond oil, macadamia oil, walnut oil can be used, modified and/or re-synthesized to achieve said goals and objectives. Said fats also can be biochemically synthesized and manufactured from several-carbon substrates.

Said fourth group of chemicals for depriving said absorbing epithelial cells of said hydrolysis products comprises: First, said third group of chemicals by depriving pancreatic juice and bile of hydrolysis substrates so that less or no hydrolysis products are produced for transportation from the lipid-aqueous interface to the absorbing cells.

Second, said coated enteric chelating agents including citric acid, said citric acid for chelating said calcium, said citric acid for suppressing the role of calcium in hydrolysis and removing hydrolysis products into the aqueous phase to suppress the activity of pancreatic lipase in said hydrolysis and said transportation of hydrolysis products to said absorbing epithelial cells.

Third, a group of fatty acid-binding proteins for transesterification with said hydrolysis products—fatty acids, monoglycerides and diglycerides—in said small intestine. Said fatty acid-binding proteins (FABPs) are ligands. All FABPs have strong affinity and bind long-chain fatty acids with differences in ligand selectivity. B-FABP is highly selective for very long-chain fatty acids. L-FABP exhibits binding capacity for a broad range of fatty acids. Strong acids like said citric acid catalyzes said biochemical reaction. Thus, FABPs deprive said absorbing epithelial cells of said hydrolysis products.

Said fifth group of chemicals are coated enteric sequester for delivering the potency of said second, third and fourth groups of chemicals, compounds and almagamated for modulating, reducing and suppressing enzymes, co-enzymes, catalysts, hormones and digestive fluids and neural receptors in the stomach, small intestine and brain. One of the preferred embodiments of the present invention is Said third group of chemicals comprises aqueous- and acid-resistant, alkali-caused disintegrable sequester for isolating or encasing said second chemicals from said milieus in said stomach, said alkali-caused disintegrable sequester for exposing said second group of chemicals to said chyme, pancreatic juice and bile including bicarbonate and fluid and small intestinal enzymes, hormones and neural receptors. In other words, said coating is able to withstand stomach acids, passes intact along with and/or in said chyme from stomach into the small intestine where said coating disintegrates to release and expose said second group of chemicals to said stomach, small intestinal, pancreatic and gall bladder enzymes, co-enzymes, catalysts, hormones and digestive fluids, bicarbonate, bile and said neural receptors. Said coatings can be manufactured natural and synthetic materials. Two of many commercial coatings comprise ingredients; First, carnuba Wax, Colloidal Silicon Dioxide, Hypromellose, Methacrylic Acid Copolymer, Microcrystaliine Cellulose, Pregelatinized Starch, Propylene Glycol Simethicone, Sodium Starch Glycolate, Stearic Acid, Talc, Titanium Dioxide. Second, black iron oxide, cellulose, colloidal silicon dioxide, corn starch, hypromellose, polydextrose, polyethylene glycol, polyviny acetate phthalate, propylene glycol, shellac wax, simethicone, sidium alginate, sodium bicarbonate, stearic acid, talc, titanium dioxide, triacetin, triethyl citrate.

Firstly, individual coated enteric compounds comprising varying types and quantities of said first, second, third and fourth groups of chemicals can be produced and manufactured. Secondly, individual coated enteric almagamated first, second, third and fourth groups in varying types and quantities can be produced and manufactured. Thirdly, individual coated enteric almagamated chemical-compounds and individual coated enteric almagamated compounds-chemical can be produced and manufactured. The compatibilities of said chemicals will determine which of and all of supra will be produced and manufactured in pills, capsules, tablets and the likes for the consumers.

A variety of animal feeds for producing animal fats having less specificity and no specificity for gastric lipase and pancreatic lipase. Said feeds comprising said fat, protein and carbohydrate moieties for said animal to produce said animal fats having less specificity and no specificity for gastric lipase and pancreatic lipase. Monounsaturated fats and polyunsaturated fats in said plant oils such as, but not limited to, canola oil, cashew oil, coconut oil, corn oil, cottonseed oil, olive oil, palm kernel oil, palm oil, peanut oil, rice bran oil, safflower oil, flaxseed oil, sesame oil, soya bean oil, almond oil, macadamia oil or walnut oil and any combinations of said oils can be fed to animals to achieve said goals and objectives. Furthermore, said animal feeds comprise canola, cashew, coconut, corn, cottonseed, olive, palm kernel, palm, peanut, rice bran, safflower, flaxseed, sesame, soya bean, almond, macadamia, walnut or any plants and plant products originating said nuts and seeds and any combinations thereof can be fed to animals to achieve said goals and objectives. Consequently, said animals fats comprise numerous permutations of said short-chain fatty acids, long-chain fatty acids and very long-chain fatty acids at 1 position, 2 position and/or 3 position some of said permutations—in emulsified lipid-aqueous interface—lack or have less specificity for said pancreatic lipase. Moreover, some of hydrolysis products such as, but not limited to, monosaturated fats, polyunsaturated fats and long-chain fatty acids can significantly slow said pancreatic lipase hydrolysis and neither said fatty acids and monoglycerides are transported away from said interface nor absorbed by said absorbing epithelial cells. A case in point, in a first report, lard comprises 39% saturated fat, 45% monounsaturated fat and 11% polyunsaturated fat. In a second report, lard has a high concentration of palmitic acid—saturated fat, a 16-carbon chain—in the 2-position. Feeding a large amount of safflower seed oil to a pig resulted in an increase in the linoleic acid—a polyunsaturated omega-6 fatty acid, an 18-carbon chain—content of said lard and a decrease in the level of the other fatty acids. Beef, butter and egg yolk, for example, have high palmitic acid C16 and moderate stearic acid C18, cattle and poultry can be fed per supra to achieve supra and said goals and objectives. And fats in butter and other dairy produce can be modified to have less specificity or no specificity for gastric lipase selections of said animals for breedings to reproduce offsprings for producing animal fats having less specificity and no specificity for gastric lipase and pancreatic lipase.

By manipulating the DNA and selective breeding of animals for synthesizing hydrolysis substrates having less and no specificity for gastric lipase and pancreatic lipase, the present invention also provides a plurality of gene-editing technologies such as, but not limited to, such as, but not limited to, Crispr-Cas9 and its derivatives—for replacing segment or segments of DNA in animal hepatocytes and adipocytes with segment or segments of DNA for synthesizing triacylglycerols having less and no specificity for gastric lipase and pancreatic lipase. Because human pancreatic lipase has substrate specificity—the rate of hydrolysis by pancreatic lipase is low for triglycerides with acetyl (C2) chains in the 1 position, is maximal for proprionyl (C3) and butryryl (C4), and decreases to a constant plateau for lauryl (C12) and longer chain as stated supra. The small intestinal hydrolysis of said hydrolysis substrates and the absorption of said hydrolysis products is very efficient by the absorbing epithelial cells of the duodenum and the first 100 cm of the jejunum in human. In other words, inserted segment or segments of DNA of said animals will synthesize animal fats comprise triacylglycerols comprising numerous permutations of said short-chain fatty acids, long-chain fatty acids and very long-chain fatty acids at 1 position, 2 position and/or 3 position some of said permutations—in emulsified lipid-aqueous interface—lack or have less specificity for said pancreatic lipase.

Further to supra, among DNA-donor animals, plants, fungus and prokaryotes in the same species, related or different species such as, but not limited to, hooved animals, avian including poultry, cold-blooded including fish and crustacean, mammal and plants, applying gene-editing technologies for inserting DNA—synthesizing said desirable saturated fat profile and unsaturated fat profile in triacylglycerols of said from DNA-donor animals—into the genes of DNA-acceptor animals producing dietary fats comprising said desirable triacyl glycerols comprising said desirable saturated fat profile and unsaturated fat profile for reducing or preventing said, animal lipids from hydrolysis by gastric lipase and pancreatic, lipase and absorbed by said absorbing epithelial cells as described supra. Selections of said animals for breedings to reproduce offsprings for producing animal fats having less specificity and no specificity for gastric lipase and pancreatic lipase. Collarary, analyzing of said desirable triacyglycerols from said settings and otherwise, selective breeding of animals and selecting said animals having said desirable saturated fat profile and unsaturated fat profile will be performed to achieve the goals and objectives of the present invention.

The sciences supporting this application can be had from various biochemistry texts and journals such as Berg J. M. et al. Biochemistry 5th edit. 2002 W.H. Freeman and Co., New York.

It is to be understood that individual singular words, phrases, terms and terminologies can also imply individual plural words, phrases, terms and terminologies, respectively, whenever and wherever correct and appropriate based on facts, realities and usage in medicine and science. And that diets, meals, foods and fluids herein encompass any and all matters and fluids which are consumed by people.

Although various preferred embodiments of the present invention have been described based on chronic diseases, particularly, cardiovascular diseases—in a nutshells, chronic diseases and other diseases shared and have many casually related etiologies and biochemical and metabolic pathways and the likes—it will be appreciated by and obvious to those skilled in the sciences that adaptations, variations and derivatives of said embodiments are and will be made and achieved for people and animals without departing from the spirit and scope of the specification of the present invention.

Although various classes, types and species of substances, materials and fluids including chemicals, materials and fluids such as, but not limited, to those described herein have been described in a preferred embodiment of the present invention, it will be appreciated by and obvious to those skilled in the sciences that same, similar and related classes, types and species of substances, materials and fluids are and will be used and applied without departing from the spirit and scope of the specification of the present invention.

Although various preferred embodiments of the present invention have been essentially described for dietary fats, it will be appreciated by and obvious to those skilled in the sciences that adaptations, variations and derivatives of said embodiments are and will be made and achieved for other nutrients and lipids in human and animal foods and diets such as, but not limited to, proteins, carbohydrates, lipids—saturated, unsaturated, animal sources and vegetable sources—medications and the likes.

Although various preferred embodiments of the present invention have been described, it will be appreciated by and obvious to those skilled in the art and science that adaptations, variations and derivatives of said embodiments are and will be made and achieved for people, animals and machines and objects without departing from the spirit and scope of the specification of the present invention.

1. A system for preventing and reducing cardiovascular and cerebrovascular diseases and metabolic syndrome, said system for reducing the productions and introductions of deleterious lipids and lipoproteins in organs for producing and synthesizing and activating the process of atherosclerosis in the coronary and cerebrovascular arteries based on said system for modulating and controlling the generations of the precursors of said lipoproteins and lipids, said system for reducing and suppressing the syntheses and productions of said precursors being the hydrolysis products in said small intestine and the transports for said precursors to the absorbing epithelial cells of said small intestine, said system for modulating and controlling said precursors flux to the liver and said truncal and central adipose tissue for synthesizing and storing said lipids and lipoproteins and flux out of said lipids and lipoproteins of the liver and adipocytes leading to hypertriglyceridemia, high-density cholesterol, increased cholesterol-rich VLDLs and elevated atherogenic small dense LDL based on said system for modulating, controlling and suppressing the acid-base and fluid milieus and enzymes, co-enzymes, catalysts, hormones and digestive fluids and neural receptors in the stomach, small intestine, said adipose tissue and brain and said system for disrupting, decreasing and suppressing the activities of enzymes, co-enzymes, catalysts, hormones and digestive fluids and neural receptors in the stomach, small intestine and brain and the secretion of insulin, said system having networks of communication devices for modulating, preventing and reducing cardiovascular and cerebrovascular diseases and metabolic syndrome based on said networks for instructing, monitoring and informing individual fulfillments, performances and achievements of said system in and among networked communication devices and printed information and illustrations for showing groups of chemicals and the indications and applications and contraindications for preventing and reducing cardiovascular and cerebrovascular diseases and metabolic syndrome and warning and a plurality of schedules for ingesting said groups of chemicals, said system comprising:
a plurality of first second, third, fourth and fifth groups of chemicals for disrupting and suppressing said productions of said precursors in said small intestine, said groups being ingested and passed from mouth, esophagus, stomach and small intestine, said groups comprising:
said first group of chemicals for reducing and suppressing stomach hydrochloric acid, enzymes, co-enzyme, catalysts, hormones for digesting and peptic hydrolyzing animal fats, proteins and polypeptides, said first group of chemicals for reducing physical, chemical and neural stimuli for generating and promoting said productions of precursors;
said first group of chemicals for modulating, controlling and suppressing stomach, duodenal and pancreatic enzymes, co-enzyme, catalysts, hormones, digestive fluid, bicarbonate, calcium, and neural receptors for generating and promoting said productions of precursors and the transportation of said hydrolysis products to said absorbing epithelial cells in the duodenum and jejunum, said first group of chemicals for modulating and suppressing the release of insulin;
said first group of chemicals for reducing and suppressing digestion and peptic hydrolysis of gastric substrates into said precursors in said stomach and hydrolysis by pancreatic lipase in small intestine by reducing and suppressing activities of stomach, duodenal and pancreatic enzymes, co-enzyme, catalysts, bicarbonate, calcium and fluid and neural receptors;
said second group of chemicals for modulating, reducing and suppressing the productions of said precursors in said small intestine;
said third group of chemicals for depriving pancreatic juice and bile of said hydrolysis substrates;
said fourth group of chemicals for depriving said absorbing epithelial cells of said hydrolysis products;
said fifth group of chemicals for delivering the potency of said second, third and fourth groups of chemicals for modulating, reducing and suppressing enzymes, co-enzymes, catalysts, hormones and digestive fluids and activities of the neural receptors in the stomach, small intestine and brain;
a plurality of compounds comprising varying types and quantities of chemicals in said first, second, third and fourth groups of chemicals;
a plurality of almagamated chemicals in said first, second, third, fourth and fifth groups in varying types and quantities of said chemicals;
exclusions of physical and chemical stimuli for producing and promoting activities of said stomach, small intestinal, pancreatic and gall bladder enzymes, co-enzymes, catalysts, hormones and digestive fluids and neural receptors;
exclusions of foods, fruits and fluids for stimulating the productions and secretions of said enzymes, co-enzymes, catalysts, hormones and digestive fluids, bicarbonate and for activating neural receptors for digesting and hydrolyzing said hydrolysis substrates before, during and after meals;
exclusions of said foods, fruits and fluids for stimulating the productions and secretions of said hormones activating the secretion of insulin;
manipulations of genes and selective breeding of animals for synthesizing hydrolysis substrates comprising less or no specificity for gastric lipase and pancreatic lipase;
rendering said networked communication devices to render said plurality of schedules for ingesting:
said first group of chemicals together with said fifth group-coated second group of chemicals,
said first group of chemicals together with said fifth group-coated third group of chemicals,
said first group of chemicals together with said fifth group-coated fourth group of chemicals;
said first group of chemicals together with said coated enteric second, third and fourth groups of chemicals;
a plurality of electronic digital menus for instructing and promoting the ingestions of specific chemicals in said first, second, third and fourth groups of chemicals based on digital menus of first plethora of diverse foods and fluids for stimulating the productions and secretions of said enzymes, co-enzymes, catalysts, hormones and digestive fluids and the activations of neural receptors in individual meals;
said plurality of electronic digital menus for instructing and promoting the ingestions of specific chemicals in said first, second, third and fourth groups of chemicals based on digital menus of second plethora of diverse foods comprising diverse types of hydrolysis substrates in individual meals;
a plurality of electronic digital menus for instructing and promoting the avoidance of and how-to-exclude said foods, fruits and fluids for stimulating the productions and secretions of said enzymes, co-enzymes, catalysts, hormones and digestive fluids, bicarbonate and for activating neural receptors for digesting and hydrolyzing said hydrolysis substrates before, during and after meals;
a plurality of electronic digital menus for instructing and promoting said avoidance of and how-to-exclude said foods, fruits and fluids for stimulating the productions and secretions of said hormones activating the secretion of insulin before, during and after meals;
printed information and illustrations for showing and illustrating said information including said avoidance of and how-to-exclude;
printed information and illustrations for showing and promoting uses of said groups of chemicals, the indications and applications and contraindications of said groups of chemicals for preventing and reducing cardiovascular and cerebrovascular diseases and metabolic syndrome and warning and said plurality of schedules for ingesting;
said printed information and illustrations for attaching to the surface of containers for storing and dispensing said groups of chemicals;
said printed information, and illustrations in said containers for storing and dispensing said groups of chemicals;
individual data on individual levels of plasma lipoproteins and lipids and metabolic syndrome in and among said networked communication devices, said networked communication devices for collecting, storing in said memories and said processor units, for collating and analyzing individual data and pooled data based on data rendered by relations of said plurality of schedules, plurality of electronic digital menus, how-to-excludes and levels of plasma lipoproteins and lipids and metabolic syndrome; and
networks of said networked communications devices comprising networked servers, smartphones, laptops and desktops having said networked repositories, said touchscreens and viewing screens, cameras, microphones, said networked repositories comprising said processor units for rendering said networks based on compilations of relations of said data, said processor units for processing, rendering and expanding individual and individual groups of compilations of relations of said data with comprehensive compilations of relations, the innovative computer programs attaching to said processor units attached to said memories, said innovative computer programs attaching to said processor units, said innovative computer programs for instructing said processor units to successively render and expand said compilations of relations in said connected constellations and in and among said memories, said memories for storing said individual and individual groups of compilations of relations with said comprehensive compilations of relations, software including said innovative computer programs, commercial operating systems for managing said networked servers and devices, the internet, commercial networking means, security means and software including web browsers.

2. The system according to claim 1 wherein said first group of chemicals for modulating, controlling and suppressing stomach, duodenal and pancreatic enzymes, co-enzyme, catalysts, bicarbonate, calcium, digestive fluid and neural receptors for generating and promoting said productions of precursors and the transportation of said hydrolysis products to said absorbing cells in the duodenum and jejunum comprises chemicals and compounds of said chemicals for producing alkali pH of the stomach wherein said first group of chemicals for:
reducing and suppressing the digestion and peptic hydrolysis by hydrochloric acid, gastric enzymes, co-enzymes, hormones, catalysts and juice and neural receptors;
suppressing gastric lipase for digesting and peptic hydrolysis of dietary fats in the stomach;
disrupting and suppressing stomach productions of stimulators of the secretions and activations of duodenal and pancreatic enzymes, co-enzymes, hormones and catalysts, bile, bicarbonate, digestive fluid and neural receptors and the release of insulin comprises said first group of chemicals for reducing, disrupting and suppressing stomach pepsin for digesting proteins and polypeptides into protein hydrolysates and amino acids being some potent stimulators of the secretions and activations of duodenal and pancreatic enzymes, co-enzymes, hormones and catalysts, bile, bicarbonate, digestive fluid and neural receptors for producing said precursors in the small intestine;
producing stomach close to or about pH 7—alkali pH for conserving stomach pepsin for digesting duodenal and pancreatic enzymes, co-enzymes and catalysts including pancreatic lipase, procolipase, colipase, lecithinases, enterokinases, endopeptidases, exopeptidases, trypsinogen and trypsin and cholecystokinin-pancreozymin, cholesterol ester hydrolase in acid-pH small intestine, stomach pepsin—an endopeptidase—active in an acid pH ranging from 1.0 to 4.0 depending on the substrates; producing range of pH's of stomach chyme close to or about pH 7—alkali pH for suppressing the secretions and activations of duodenal and pancreatic enzymes, co-enzymes, hormones, bile and digestive fluids including bicarbonate and neural receptors for digesting and hydrolyzing hydrolysis substrates in said small intestine; and
reducing and suppressing stomach foods and fluids including chyme for stimulating the release of intestinal hormones and neural receptors for stimulating the release of insulin.

3. The first group of chemicals according to claim 2 comprise anions comprising carbonates, bicarbonates and hydroxides; and histamine H2-receptor blockers.

4. The system according to claim 1 wherein said second group of chemicals for modulating, reducing and suppressing the productions of said precursors in said small intestine comprise:
said first group of chemicals:
chemicals for reducing and suppressing activities of stomach, duodenal and pancreatic enzymes, co-enzymes, catalysts, hormones and digestive fluids and neural receptors in the stomach, small intestine and brain for generating said precursors in said small intestine and the transportation and delivery of said hydrolysis products to said absorbing epithelial cells, said chemicals for producing acid pH of the duodenum and jejunum;
chelating agents for binding calcium for participating in the productions of said precursors by pancreatic lipase in said small intestine;
chemicals for reducing and suppressing the activities of lipase, procolipase, colipase, lecithinases, enterokinases, endopeptidases, exopeptidases, trypsinogen and trypsin and cholecystokinin-pancreozymin, cholesterol ester hydrolase in said duodenum and jejunum;
chemicals for competitively occupying the lipid-aqueous interface;
chemicals for digesting said pancreatic lipase, colipase, lecithinases, enterokinases, trypsinogen and trypsin and cholecystokinin-pancreozymin, cholesterol ester hydrolase;
chemicals for binding to fatty acids of triglycerides in said small intestine;
chemicals for binding to said hydrolysis products comprising fatty acids and monoglycerides;
chemicals for transesterification of hydrolysis products, said transesterification for disrupting and suppressing said hydrolysis, removal and transportation of hydrolysis products from sites of hydrolysis to the the absorbing epithelial cells; and
chemicals for slowing the digestions and hydrolysis of lipid substrates in the small intestine.

5. The chemicals for reducing and suppressing activities of stomach, duodenal and pancreatic enzymes, co-enzymes, catalysts, hormones and digestive fluids and neural receptors in the stomach, small intestine and brain for generating said precursors in said small intestine and the transportation and delivery of said hydrolysis products to said absorbing epithelial cells, said chemicals for producing acid pH of the duodenum and jejunum according to claim 4 comprise:
said conserved stomach pepsin for digesting polypeptides which are pancreatic lipase, procolipase, colipase, lecithinases, enterokinases, trypsinogen and trypsin and cholecystokinin-pancreozymin, cholesterol ester hydrolase in said rendered acid-pH small intestine.
ascorbic acid for producing acid pH for suppressing the activities of pancreatic lipase, procolipase, colipase, trypsinogen, trypsin, cholecystokinin-pancreozymin, cholesterol ester hydrolase, bile, fluid and bicarbonate, said ascorbic acid is coated enteric ascorbic acid;
said coated enteric ascorbic acid for producing acid pH for suppressing the emulsification by amino acids, lecithin, lysolecithin, fatty acids, monoglycerides, diglycerides, and bile acids, said ascorbic acid is coated enteric ascorbic acid;
citric acid for producing acid pH for suppressing the activities of pancreatic lipase, procolipase, colipase, trypsinogen, trypsin, cholecystokinin-pancreozymin, cholesterol ester hydrolase, bile, fluid and bicarbonate, said citric acid is coated enteric citric acid;
said coated enteric citric acid for producing acid pH for suppressing the emulsification by amino acids, lecithin, lysolecithin, fatty acids, monoglycerides, diglycerides, and bile acids;
said coated enteric chelating agents including citric acid, said citric acid for chelating said calcium, said citric acid for suppressing the role of calcium in hydrolysis and removing hydrolysis products into the aqueous phase to suppress the activity of pancreatic lipase in said hydrolysis and said transportation of hydrolysis products to said absorbing cells;
said third group of chemicals for depriving pancreatic juice and bile of said hydrolysis substrates;
coated enteric of said compounds comprising varying types and quantities of chemicals in said first, second, third and fourth groups of chemicals; and
coated enteric of said almagamated chemicals in said first, second, third, fourth and fifth groups in varying types and quantities of said chemicals.

6. The system according to claim 1 wherein said third group of chemicals for depriving pancreatic juice and bile of said hydrolysis substrates comprise:
animal, plant, man-made and synthetic lipids and any combination thereof said chemicals for producing emulsifications comprising said lipid-aqueous interface for competing with dietary lipid-aqueous interface for pancreatic lipase at said interfaces where pancreatic lipase is active;
animal feeds for producing animal fats having less specificity and no specificity for gastric lipase and pancreatic lipase;
selective breeding of animals producing said animal fats having said triacylglycerols having no specificity for gastric lipase and pancreatic lipase; and
selections of said animals for breedings for producing offsprings for producing animal fats having less specificity and no specificity for gastric lipase and pancreatic lipase.

7. The animal feeds according to claim 6 comprise plants, plant oils, vegetable, vegetable oils, seed and seed oils comprise:
monounsaturated fats and polyunsaturated fats;
triacylglycerols comprising long chain fatty acids and very long chain fatty acids in 1 position, 2 position and 3 position;
plant proteins and carbohydrate; and animal proteins and carbohydrate.

8. The system according to claim 1 wherein said fourth group of chemicals for depriving said absorbing epithelial cells of said hydrolysis products comprises:
said third group of chemicals for depriving pancreatic juice and bile of said hydrolysis substrates;
said coated enteric chelating agents including citric acid, said citric acid for chelating said calcium, said citric acid for suppressing the role of calcium in hydrolysis and removing hydrolysis products into the aqueous phase to suppress the activity of pancreatic lipase in said hydrolysis and said transportation of hydrolysis products to said absorbing epithelial cells;
said third group of chemicals for depriving pancreatic juice and bile of said hydrolysis substrates;
and chemicals for transesterification of said hydrolysis products.

9. The chemicals for transesterification of said hydrolysis products according to claim 8 are ligands and acids comprising:
a group of fatty acid-binding proteins for binding said fatty acids and monoglycerides which are said digestion products and hydrolysis products in said small intestine;
coated enteric group of fatty acid-binding proteins for binding said hydrolysis products in said small intestine;
said coated enteric ascorbic acid for catalyzing said bindings of said fatty acid-binding proteins and said fatty acids, monoglycerides and triacylglycerols in said small intestine; and
said coated enteric citric acid for catalyzing said bindings of said fatty acid-binding proteins and said fatty acids, monoglycerides and triacylglycerols in said small intestine.

10. The system according to claim 1 wherein said fifth group of chemicals comprises aqueous- and acid-resistant, alkali-caused disintegrable sequesters for isolating or encasing said second, third and fourth group of chemicals from oral, esophageal and stomach contents and milieus, said alkali-caused disintegrable sequester for disintegrating and exposing said second, third and fourth groups of chemicals to said chyme, pancreatic juice and bile including bicarbonate and fluid and small intestinal enzymes, hormones and neural receptors, said disintegrable sequesters are manufactured, natural and synthetic protective coatings and any combinations thereof.

11. The system according to claim 1 wherein said manipulations of genes and selective breeding of animals for synthesizing hydrolysis substrates comprising less or no specificity for gastric lipase and pancreatic lipase comprises:
a plurality of gene-editing technologies for replacing segment or segments of DNA in animal hepatocytes and adipocytes with segment or segments of DNA for synthesizing triacylglycerols having less specificity for human gastric lipase and human pancreatic lipase,
a plurality of gene-editing technologies for replacing segment or segments of DNA in animal hepatocytes and adipocytes with segment or segments of DNA for synthesizing triacylglycerols having no specificity for gastric lipase and pancreatic lipase,
among DNA-donor animals, plants, fungus and prokaryotes in the same species, related or different species; and
selective breeding of animals and selecting said animals having said triacylglycerols having no specificity for gastric lipase and pancreatic lipase.

12. The system according to claim 1 wherein said exclusions of physical and chemical stimuli for producing and promoting activities of said stomach, small intestinal, pancreatic and gall enzymes, co-enzymes, catalysts, hormones and digestive fluids and neural receptors, said exclusions are acidic foods, fruits and fluids, certain types of vegetable oils, protein hydrolysates, amino acids, fatty acids, water, sodium chloride and carbohydrate and any mixtures and combinations thereof before, during and after meals.

13. The system according to claim 1 wherein said system having networks of communication devices for modulating, preventing and reducing cardiovascular and cerebrovascular diseases and metabolic syndrome, said networked communication devices for displaying lists and instructions comprising:
first exclusion of said acidic foods and fruits, acidic fluids such as, but not limited to, alcoholic and carbonated beverages, vinegars in salad dressings, fruit juices, tea and coffee and a long list of other acidic fluids being consumed by people and chyme, certain types of vegetable oils such as, but not limited to, oleate, protein hydrolysates, amino acids, fatty acids, water, sodium chloride and carbohydrate before, during and after meals will reduce and suppress said digestions and hydrolysis in the stomach and small intestine.
second exclusion of amino acids, certain types of vegetable oils such as, but not limited to, oleate and corn oil, alcoholic and carbonated beverages, vinegars in salad dressings, fruit juices, tea and coffee and a long list of other acidic fluids, water, sodium chloride and carbohydrate which change the rates of cholecystokinin-pancreozymin release which causes the secretions of bile and pancreatic juice into the small intestine;
said networked communication devices for displaying a plurality of schedules for ingesting:
said first group of chemicals together with said coated enteric second group of chemicals,
said first group of chemicals together with said coated enteric third group of chemicals,
said first group of chemicals together with said coated enteric fourth group of chemicals,
said first group of chemicals together with said coated enteric second, third and fourth groups of chemicals;
a plurality of electronic digital menus for ingesting specific chemicals in said first, second, third and fourth groups and any combinations thereof based on digital menus of first plethora of diverse foods and fluids for stimulating the productions and secretions of said enzymes, co-enzymes, catalysts, hormones and digestive fluids and the activations of neural receptors in individual meals;
said plurality of electronic digital menus for ingesting specific chemicals in in said first, second, third and fourth groups and any combinations thereof based on digital menus of second plethora of diverse foods comprising diverse types of hydrolysis substrates in individual meals; and
said networks for instructing, monitoring and informing individual fulfillments, performances and achievements of said system in and among networked communication devices.

14. The system according to claim 1 wherein said networks for instructing, monitoring and informing individual fulfillments, performances and achievements of said system in and among networked communication devices according to claim 1 comprises said networked communication devices for collecting and storing individual data on individual levels of plasma lipoproteins and lipids and metabolic syndrome consequent to the utilizations of said system in and among said memories of said networked communication devices, said processor units for pooling and analyzing individual data and pooled data based on data rendered by relations of said plurality of schedules, plurality of electronic digital menus and levels of plasma lipoproteins and lipids and metabolic syndrome.

15. In a system for preventing and reducing cardiovascular and cerebrovascular diseases and metabolic syndrome, a method for modulating and control ling of the productions in and introductions of deleterious lipoproteins and lipids to organs for producing and synthesizing and activating the process of atherosclerosis in the coronary and cerebrovascular arteries and metabolic syndrome by reducing and suppressing the generations of the precursors of said lipoproteins and lipids whereby reducing and suppressing the syntheses and productions of said precursors being the hydrolysis products in said small intestine and the transportation for said precursors to the absorbing epithelial cells of said small intestine thereby modulating, controlling and reducing said precursors flux to the liver and truncal and central adipose tissue for synthesizing and storing said lipids and lipoproteins and flux out of said lipids and lipoproteins of the liver and adipocytes leading to hypertriglyceridemia, high-density cholesterol, increased cholesterol-rich VLDLs and elevated atherogenic small dense LDL based on said method, for modulating, controlling and suppressing the acid-base and fluid milieus and secretions and activities of enzymes, co-enzymes, catalysts, hormones and digestive fluids and neural receptors and secretion of insulin, said method for modifying, reducing and suppressing said milieus, secretions and activities in the stomach, small intestine, brain and pancreas by rendering networks of communication devices for instructing, monitoring and informing individual fulfillments, performances and achievements of said system in and among said networked communication devices and printed information and illustrations of relations of said groups of chemicals and exclusions of diets before, during and after meals, the indications and applications and applications and contraindications preventing and reducing cardiovascular and cerebrovascular diseases and metabolic syndrome and warning and a plurality of schedules for ingesting said groups of chemicals, said method comprises processes for:
manufacturing said first, second, third, fourth and fifth groups of chemicals and said fifth group to coat and sequester said second, third and fourth groups;
manufacturing said first, second, third and fourth groups of chemicals for disrupting and suppressing said productions of said precursors and for ingesting and passing said chemicals from mouth, esophagus, stomach and small intestine, said plurality of groups of chemicals disrupting and suppressing said productions of said precursors in the stomach and small intestine;
manufacturing said first group of chemicals modulating and controlling hormones and neural stimuli for generating and promoting said productions of precursors in the stomach and small intestine;
manufacturing said first group of chemicals reducing and suppressing digestion and hydrolysis of hydrolysis substrates into said precursors in said stomach and small intestine by reducing and suppressing activities of stomach, duodenal and pancreatic enzymes, co-enzyme, catalysts, bicarbonate, calcium and fluid and neural receptors and reducing and suppressing the releases of secretin which causes the release of insulin;
manufacturing said first group of chemicals for reducing physical, chemical and neural stimuli for generating and promoting said productions of precursors;
manufacturing said second group of chemicals modulating, reducing and suppressing enzymes, co-enzyme, catalysts, hormones, digestive juices and neural receptors in said stomach and small intestine whereby said second group of chemicals modulating, reducing and suppressing the productions of said precursors in said stomach and small intestine;
procuring and manufacturing said third group of chemicals for depriving pancreatic juice and bile of said hydrolysis substrates;
manufacturing said fourth group of chemicals for depriving said absorbing epithelial cells of said hydrolysis products;
manufacturing said fifth group of chemicals delivering the potency of second, third and fourth groups of chemicals to the small intestine by sequestering second, fourth and fifth groups from mouth, esophagus and stomach milieus and by releasing and exposing said second, fourth and fifth groups to modulate, reduce and suppress activities of enzymes, co-enzyme, catalysts, hormones, digestive juices and neural receptors in the small intestine and reducing and suppressing the releases of secretin which causes the release of insulin;
manufacturing a plurality of compounds comprising varying types and quantities of chemicals in said first, second, third and fourth groups of chemicals;
manufacturing a plurality of almagamated chemicals in said first, second, third, fourth and fifth groups in varying types and quantities of said chemicals;
feeding animals with feeds for producing animal fats having less specificity and no specificity for gastric lipase and pancreatic lipase;
excluding foods, fruits and fluids stimulating the productions and secretions of said enzymes, co-enzymes, catalysts, hormones and digestive fluids, bicarbonate and for activating neural receptors before, during and after meals;
excluding said foods, fruits and fluids stimulating the productions and secretions of said hormones activating the secretion of insulin;
rendering said networked communication devices and prints to render said plurality of schedules for ingesting:
said first group of chemicals together with said fifth group-coated second group of chemicals,
said first group of chemicals together with said fifth group-coated third group of chemicals,
said first group of chemicals together with said fifth group-coated fourth group of chemicals;
said first group of chemicals together with said coated enteric second, third and fourth groups of chemicals;
manipulating animal genes for producing animals synthesizing and produce hydrolysis substrates comprising less or no specificity for gastric lipase and pancreatic lipase and selective breeding of said animals;
rendering a plurality of electronic digital menus to instruct and promote the ingestions of specific chemicals, in said first, second, third and fourth groups of chemicals based on digital menus of first plethora of diverse foods and fluids for stimulating the productions and secretions of said enzymes, co-enzymes, catalysts, hormones and digestive fluids and the activations of neural receptors in individual meals;
rendering said plurality of electronic digital menus to instruct and promote the ingestions of specific chemicals in said first, second, third and fourth groups of chemicals based on digital menus of second plethora of diverse foods comprising diverse types of hydrolysis substrates in individual meals;
rendering a plurality of electronic digital menus to instruct and promote the avoidance of and how-to-exclude said foods, fruits and fluids for stimulating the productions and secretions of said enzymes, co-enzymes, catalysts, hormones and digestive fluids, bicarbonate and for activating neural receptors for digesting and hydrolyzing said hydrolysis substrates before, during and after meals;
rendering a plurality of electronic digital menus to instruct and promote the avoidance of and how-to-exclude said foods, fruits and fluids for stimulating the productions and secretions of said hormones activating the secretion of insulin before, during and after meals;
printing and copying printed information and illustrations of said avoidance of and how-to-exclude;
printing and copying printed information and illustrations showing and promoting uses of said groups of chemicals, the indications and applications and contraindications of said groups of chemicals for preventing and reducing cardiovascular and cerebrovascular diseases and metabolic syndrome and warning and said plurality of schedules for ingesting;
attaching said printed information and illustrations to the surface of containers for storing and dispensing said groups of chemicals;
enclosing said printed information and illustrations in said containers for storing and dispensing said groups of chemicals; and
rendering individual data on individual levels of plasma lipoproteins and lipids and metabolic syndrome in and among said networked communication devices, said networked communication devices are rendered to collect, store in said memories and said processor units to collate and analyze individual data and pooled data based on data rendered by relations of said plurality of schedules, plurality of electronic digital menus, how-to-excludes and levels of plasma lipoproteins and lipids and metabolic syndrome; and
rendering networks of said networked communications devices comprising networked servers, smartphones, laptops and desktops having said networked repositories, said touchscreens and viewing screens, cameras, microphones, said networked repositories comprising said processor units, said processor units rendering said networks based on compilations of relations of said data, said processor units processing, rendering and expanding individual and individual groups of compilations of relations of said data with comprehensive compilations of relations, the innovative computer programs attaching to said processor units attached to said memories, said innovative computer programs attaching to said processor units, said innovative computer programs instructing said processor units to successively render and expand said compilations of relations in said connected constellations and in and among said memories, said memories storing said individual and individual groups of compilations of relations with said comprehensive compilations of relations, software including said innovative computer programs, commercial operating systems managing said networked servers and devices, the Internet, commercial networking means, security means and software including web browsers.

16. The method according to claim 15 wherein said process for manipulating animal genes for producing animals synthesizing and produce hydrolysis substrates comprising less or no specificity for gastric lipase and pancreatic, lipase and selective breeding of said animals comprises processes for:
gene-editing segment or segments of DNA in animal hepatocytes and adipocytes with segment or segments of DNA for synthesizing triacylglycerols having less specificity for human gastric lipase and human pancreatic lipase,
gene-editing segment or segments of DNA in animal hepatocytes and adipocytes with segment or segments of DNA for synthesizing triacylglycerols having no specificity for gastric lipase and pancreatic lipase,
using said DNA segment and DNA segments from DNA-donor animals in the same species, related or different species, plants, fungus and prokaryotes;
selective breeding of said animals having said triacylglycerols having no specificity for gastric lipase and pancreatic lipase; and
selecting said animals for further breedings.

17. The method according to claim 15 wherein said networks of communication devices for instructing, monitoring and informing individual fulfillments, performances and achievements of said system in and among said networked communication devices and printed information and illustrations of relations of said groups of chemicals and exclusions of diets before, during and after meals, said method comprises processes for:
rendering said networks of communication devices modulating, preventing and reducing cardiovascular and cerebrovascular diseases and metabolic syndrome;
rendering said networked communication devices displaying lists and instructions to:
exclude said acidic foods, fruits and fluids, certain types of vegetable oils, protein, amino acids, fatty acids, water, sodium chloride and carbohydrate before, during and after meals to reduce and suppress said digestions and hydrolysis in the stomach and small intestine;
exclude amino acids, certain types of vegetable oils, acidic foods, fluids and fruits, water, sodium chloride and carbohydrate before, during and after meals to reduce and suppress cholecystokinin-pancreozymin release which causes the secretions of bile and pancreatic juice into the small intestine;
displaying a plurality of schedules for ingesting:
said first group of chemicals together with said coated enteric second group of chemicals,
said first group of chemicals together with said coated enteric third group of chemicals,
said first group of chemicals together with said coated enteric fourth group of chemicals,
said first group of chemicals together with said coated enteric second, third and fourth groups of chemicals;
rendering a plurality of electronic digital menus for ingesting specific chemicals in said first, second, third and fourth groups and any combinations thereof based on digital menus of first plethora of diverse foods, fluids and fruits for stimulating the productions and secretions of said enzymes, co-enzymes, catalysts, hormones and digestive fluids and the activations of neural receptors in the meals;
rendering said plurality of electronic digital menus for ingesting specific chemicals in said first, second, third and fourth groups and any combinations thereof based on digital menus of second plethora of diverse foods, fluids and fruits comprising diverse types of said hydrolysis substrates in the meals;
rendering said networks instructing, monitoring and informing individual fulfillments, performances and achievements of said system in and among networked communication devices and
rendering printed information and illustrations of said relations of said groups of chemicals and said excluded foods, fluids and fruits, said schedules and menus.

18. In a system for preventing and reducing cardiovascular and cerebrovascular diseases and metabolic syndrome, a method for producing a plurality of groups of chemicals to prevent and reduce cardiovascular and cerebrovascular diseases and metabolic syndrome by said groups of chemicals being ingested to disrupt, decrease and suppress the activities of enzymes, co-enzymes, catalysts, hormones, bicarbonate and digestive fluids and neural receptors in the stomach, small intestine, pancreas, brain and adipose tissue in particular truncal and central adipose tissue to reduce and suppress the productions of the precursors of plasma lipoproteins and lipids involved in the arterial atherosclerosis process and metabolic syndrome, said method for rendering networks of communication devices for instructing, monitoring and informing individual fulfillments, performances and achievements of said system in and among said networked communication devices and printed information and illustrations of relations of said groups of chemicals and exclusions of diets before, during and after meals, said networked communication devices and printed information and illustrations showing groups of chemicals and the indications and applications and contraindications for preventing and reducing cardiovascular and cerebrovascular diseases and metabolic syndrome and warning and a plurality of schedules for ingesting said groups of chemicals, said method comprises processes for:
manufacturing said first, second, third, fourth and fifth groups of chemicals and said fifth group to coat and sequester said second, third and fourth groups;
manufacturing said first, second, third and fourth groups of chemicals for disrupting and suppressing said productions of said precursors and for ingesting and passing said chemicals from mouth, esophagus, stomach and small intestine, said plurality of groups of chemicals disrupting and suppressing said productions of said precursors in the stomach and small intestine;
manufacturing said first group of chemicals modulating and controlling hormones and neural stimuli for generating and promoting said productions of precursors in the stomach and small intestine;
manufacturing said first group of chemicals reducing and suppressing digestion and hydrolysis of hydrolysis substrates into said precursors in said stomach and small intestine by reducing and suppressing activities of stomach, duodenal and pancreatic enzymes, co-enzyme, catalysts, bicarbonate, calcium and fluid and neural receptors and reducing and suppressing the releases of secretin which causes the release of insulin;
manufacturing said second group of chemicals modulating, reducing and suppressing enzymes, co-enzyme, catalysts, hormones, digestive juices and neural receptors in said stomach and small intestine whereby said second group of chemicals modulating, reducing and suppressing the productions of said precursors in said stomach and small intestine;
procuring and manufacturing said third group of chemicals for depriving pancreatic juice and bile of said hydrolysis substrates;
manufacturing said fourth group of chemicals for depriving said absorbing epithelial cells of said hydrolysis products;
manufacturing said fifth group of chemicals delivering the potency of second, third and fourth groups of chemicals to the small intestine by sequestering second, fourth and fifth groups from mouth, esophagus and stomach milieus and by releasing and exposing said second, fourth and fifth groups to modulate, reduce and suppress activities of enzymes, co-enzyme, catalysts, hormones, digestive juices and neural receptors in the small intestine and reducing and suppressing the releases of secretin which causes the release of insulin;
manufacturing a plurality of compounds comprising varying types and quantities of chemicals in said first, second, third and fourth groups of chemicals;
manufacturing a plurality of almagamated chemicals in said first, second, third, fourth and fifth groups in varying types and quantities of said chemicals;
feeding animals with feeds for producing animal fats having less specificity and no specificity for gastric lipase and pancreatic lipase;
excluding foods, fruits and fluids stimulating the productions and secretions of said enzymes, co-enzymes, catalysts, hormones and digestive fluids, bicarbonate and for activating neural receptors before, during and after meals;
excluding said foods, fruits and fluids stimulating the productions and secretions of said hormones activating the secretion of insulin;
rendering said networked communication devices and prints to render said plurality of schedules for ingesting:
said first group of chemicals together with said fifth group-coated second group of chemicals,
said first group of chemicals together with said fifth group-coated third group of chemicals,
said first group of chemicals together with said fifth group-coated fourth group of chemicals;
said first group of chemicals together with said coated enteric second, third and fourth groups of chemicals;
rendering a plurality of electronic digital menus to instruct and promote the ingestions of specific chemicals in said first, second, third and fourth groups of chemicals based on digital menus of first plethora of diverse foods and fluids for stimulating the productions and secretions of said enzymes, co-enzymes, catalysts, hormones and digestive fluids and the activations of neural receptors in individual meals;
manipulating animal genes for producing animals synthesizing and produce hydrolysis substrates comprising less or no specificity for gastric lipase and pancreatic lipase and selective breeding of said animals;
rendering said plurality of electronic digital menus to instruct and promote the ingestions of specific chemicals in said first, second, third and fourth groups of chemicals based on digital menus of second plethora of diverse foods comprising diverse types of hydrolysis substrates in individual meals;
rendering a plurality of electronic digital menus to instruct and promote the avoidance of and how-to-exclude said foods, fruits and fluids for stimulating the productions and secretions of said enzymes, co-enzymes, catalysts, hormones and digestive fluids, bicarbonate and for activating neural receptors for digesting and hydrolyzing said hydrolysis substrates before, during and after meals;
rendering a plurality of electronic digital menus to instruct and promote said avoidance of and how-to-exclude said foods, fruits and fluids for stimulating/the productions and secretions of said hormones activating the secretion of insulin before, during and after meals;
printing and copying printed information and illustrations of said avoidance of and how-to-exclude;
printing and copying printed information and illustrations showing and promoting uses of said groups of chemicals, the indications and applications and contraindications of said groups of chemicals for preventing and reducing cardiovascular and cerebrovascular diseases and metabolic syndrome mid warning and said plurality of schedules for ingesting;
attaching said printed information and illustrations to the surface of containers for storing and dispensing said groups of chemicals;
enclosing said printed information and illustrations in said containers for storing and dispensing said groups of chemicals; and
rendering individual data on individual levels of plasma lipoproteins and lipids and metabolic syndrome in and among said networked communication devices, said networked communication devices are rendered to collect, store in said memories and said processor units to collate and analyze individual data and pooled data based on data rendered by relations of said plurality of schedules, plurality of electronic digital menus, how-to-excludes and levels of plasma lipoproteins and lipids and metabolic syndrome; and
rendering networks of said networked communications devices comprising networked servers, smartphones, laptops and desktops having said networked repositories, said touchscreens and viewing screens, cameras, microphones, said networked repositories comprising said processor units, said processor units rendering said networks based on compilations of relations of said data, said processor units processing, rendering and expanding individual and individual groups of compilations of relations of said data with comprehensive compilations of relations, the innovative computer programs attaching to said processor units attached to said memories, said innovative computer programs attaching to said processor units, said innovative computer programs instructing said processor units to successively render and expand said compilations of relations in said connected constellations and in and among said memories, said memories storing said individual and individual groups of compilations of relations with said comprehensive compilations of relations, software including said innovative computer programs, commercial operating systems managing said networked servers and devices, the Internet, commercial networking means, security means and software including web browsers.

19. The method according to claim 18 wherein said process for manipulating animal genes for producing animals synthesizing and produce hydrolysis substrates comprising less or no specificity for gastric lipase and pancreatic lipase and selective breeding of said animals comprises processes for:
gene-editing segment or segments of DMA in animal hepatocytes and adipocytes with segment or segments of DNA for synthesizing triacylglycerols having less specificity for human gastric lipase and human pancreatic lipase,
gene-editing segment or segments of DNA in animal hepatocytes and adipocytes with segment or segments of DNA for synthesizing triacylglycerols having no specificity for gastric lipase and pancreatic lipase,
using said DNA segment and DNA segments from DNA-donor animals in the same species, related or different species, plants, fungus and prokaryotes;
selective breeding of said animals having said triacylglycerols having no specificity for gastric lipase and pancreatic lipase; and
selecting said animals for further breedings.

20. The method according to claim 18 wherein said networks of communication devices for instructing, monitoring and informing individual fulfillments, performances and achievements of said system in and among said networked communication devices and printed information and illustrations of relations of said groups of chemicals and exclusions of diets before, during and alter meals, said method comprises processes for:
rendering said networks of communication devices modulating, preventing and reducing cardiovascular and cerebrovascular diseases and metabolic syndrome;
rendering said networked communication devices displaying lists and instructions to:
exclude said acidic foods, fruits and fluids, certain types of vegetable oils, protein, amino acids, fatty acids, water, sodium chloride and carbohydrate before, during and after meals to reduce and suppress said digestions and hydrolysis in the stomach and small intestine;
exclude amino acids, certain types of vegetable oils, acidic foods, fluids and fruits, water, sodium chloride and carbohydrate before, during and after meals to reduce and suppress cholecystokinin-pancreozymin release which causes the secretions of bile and pancreatic juice into the small intestine;
displaying a plurality of schedules for ingesting:
said first group of chemicals together with said coated enteric second group of chemicals,
said first group of chemicals together with said coated enteric third group of chemicals,
said first group of chemicals together with said coated enteric fourth group of chemicals,
said first group of chemicals together with said coated enteric second, third and fourth groups of chemicals;
rendering a plurality of electronic digital menus for ingesting specific chemicals in said first, second, third and fourth groups and any combinations thereof based on digital menus of first plethora of diverse foods, fluids and fruits for stimulating the productions and secretions of said enzymes, co-enzymes, catalysts, hormones and digestive fluids and the activations of neural receptors in the meals;
rendering said plurality of electronic digital menus for ingesting specific chemicals in in said first, second, third and fourth groups and any combinations thereof based on digital menus of second plethora of diverse foods, fluids and fruits comprising diverse types of said hydrolysis substrates in the meals;
rendering said networks instructing, monitoring and informing individual fulfillments, performances and achievements of said system in and among networked communication devices; and
rendering printed information and illustrations of said relations of said groups of chemicals and said excluded foods, fluids and fruits, said schedules and menus.
